(19) United States
(12) Patent Application Publication
(10) Pub. No.: US 2012/0047445 A1
(43) Pub. Date: Feb. 23, 2012

(54) PRE-FETCHING PAGES AND RECORDS IN AN ON-DEMAND SERVICES ENVIRONMENT

(75) Inventor: Vinodh Kumar Rajagopal, Mountain View, CA (US)

(73) Assignee: SALESFORCE.COM, INC., San Francisco, CA (US)

(21) Appl. No.: 12/860,503

(22) Filed: Aug. 20, 2010

(51) Int. Cl. G06F 3/048; H04L 9/32

(52) U.S. Cl. 715/747; 726/7

(57) ABSTRACT

An approach for pre-fetching pages and records in an on demand services environment is disclosed. This approach for pre-fetching pages and records provides for rendering data directly from a locally saved copy. Particular embodiments can include providing a user interface (UI) for a user of the on-demand services environment. According to requests received via the UI, the server can check for a user's log-in credentials. Depending upon the user's activity history, the server can also predict pages which would likely be visited by the user, store those pages as a local copy, and pre-send those pages in advance to the user.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates to pre-fetching of pages and records in an on-demand services environment.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In conventional database systems, users access their data resources in one logical database. A user of such a conventional system typically retrieves data from and stores data on the system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request.

Unfortunately, in conventional web database systems, when a user wants to access a webpage, the user, through their web browser, first logs on to the network system to retrieve a desired webpage. The browser requests the desired page and the web server hosting the webpage sends it to the user. This request and retrieve page loading process can be relatively inefficient and time consuming, particularly, when the user tries to go to those pages when there is a lot of network traffic.

### BRIEF SUMMARY

In accordance with particular embodiments, pre-fetching of pages and records in an on demand service environment is provided. Data can be rendered directly from the locally saved copy in order to enable a faster load time experience to the user.

In an embodiment and by way of example, a method for pre-fetching pages and records in an on-demand services environment is provided. This particular method includes providing a user interface (UI) for a user of the on-demand services environment. According to requests received via the UI, a server may check for the user's log-in credentials. Depending upon the user's activity history, the server can predict the pages which would likely to be visited by the user, store those pages as a local copy, and pre-send those pages in advance to the user.

While the present invention is described with reference to an embodiment in which techniques for pre-fetching pages and records in an on demand service environment are implemented in a system having an application server providing a front end for an on-demand database service capable of supporting multiple tenants, the present invention is not limited to multi-tenant databases or deployment on application servers. Embodiments may be practiced using other database architectures, i.e., ORACLE®, DB2® by IBM and the like without departing from the scope of the embodiments claimed.

Any of the above embodiments may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples of the invention, the invention is not limited to the examples depicted in the figures;

FIG. 1 illustrates a block diagram of an example of an environment wherein an on-demand database service might be used;

FIG. 2 illustrates a block diagram of an embodiment of elements of FIG. 1 and various possible interconnections between these elements;

FIG. 3 illustrates an example simplified block diagram illustrating page pre-fetching;

FIG. 4 illustrates an example simplified flow diagram illustrating server-side pre-fetching; and

FIG. 5 illustrates an example simplified flow diagram illustrating client-side pre-fetching.

### DETAILED DESCRIPTION

### General Overview

Systems and methods are provided for pre-fetching pages and records in an on demand services environment.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for providing pre-fetching pages and records in an on demand services environment will be described with reference to example embodiments.

### System Overview

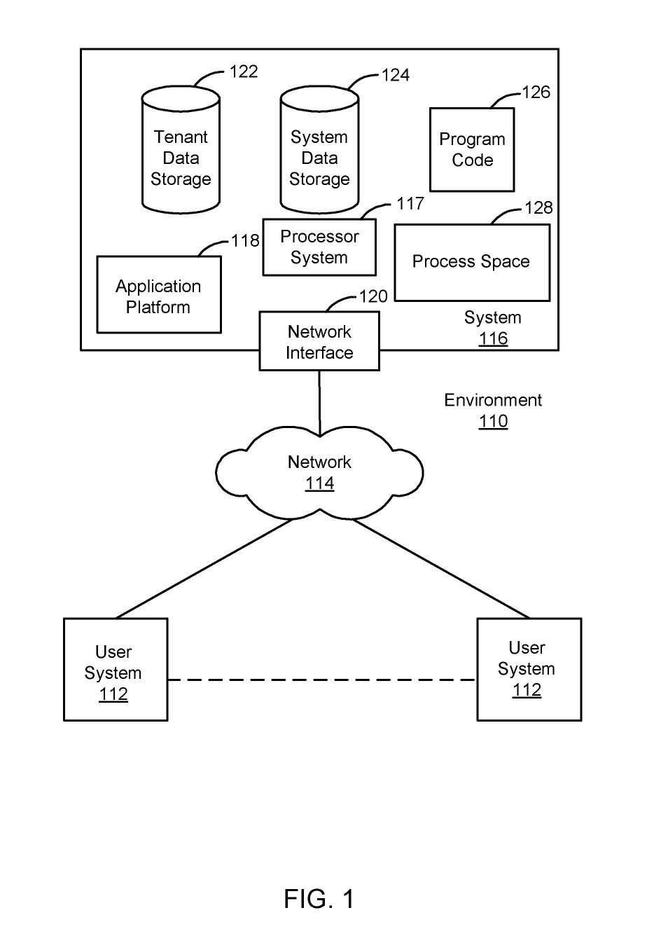

FIG. 1 illustrates a block diagram of an environment 110 wherein an on-demand database service might be used. Environment 110 may include user systems 112, network 114, system 116, processor system 117, application platform 118, network interface 120, tenant data storage 122, system data storage 124, program code 126, and process space 128. In other embodiments, environment 110 may not have all of the components listed and/or may have other elements instead of, or in addition to, those listed above.

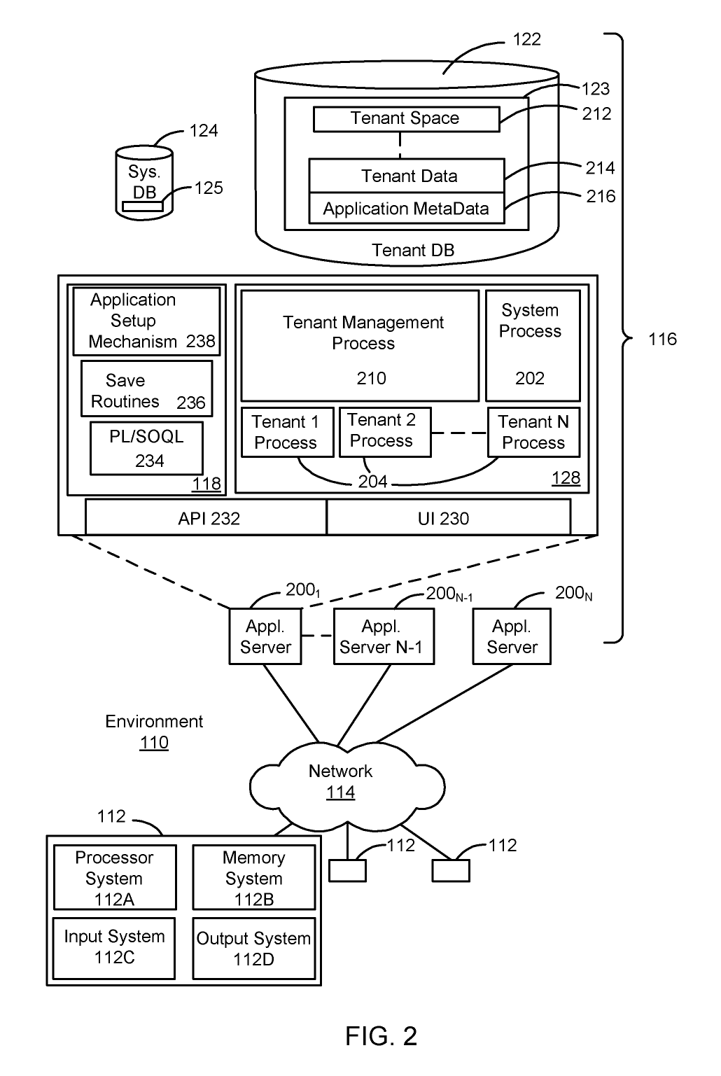

Environment 110 is an environment in which an on-demand database service exists. User system 112 may be any machine or system that is used by a user to access a database user system. For example, any of user systems 112 can be a handheld computing device, a mobile phone, a laptop computer, a work station, and/or a network of computing devices. As illustrated in FIG. 1 (and in more detail in FIG. 2) user systems 112 might interact via a network 114 with an on-demand database service, which is system 116.

An on-demand database service, such as system 116, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 116” and “system 116” will be used interchangeably herein. A database image may include one or more database objects. A relational database management system (RDMS) or the equivalent may execute storage and retrieval of information against the database object(s). Application platform 118 may be a framework that allows the applications of system 116 to run, such as the hardware and/or software, e.g., the operating system. In an embodiment, on-demand database service 116 may include an application platform 118 that enables creation, managing and executing one or more applications developed by the provider of the on-demand database service, users accessing the on-demand database service via user systems 112, or third party application developers accessing the on-demand database service via user systems 112.

The users of user systems 112 may differ in their respective capacities, and the capacity of a particular user system 112 might be entirely determined by permissions (permission levels) for the current user. For example, where a salesperson is using a particular user system 112 to interact with system 116, that user system has the capacities allotted to that salesperson. However, while an administrator is using that user system to interact with system 116, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 114 is any network or combination of networks of devices that communicate with one another. For example, network 114 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the present invention might use are not so limited, although TCP/IP is a frequently implemented protocol.

User systems 112 might communicate with system 116 using TCP/IP and, at a higher network level, use other common Internet protocols to communicate, such as HTTP, FTP, AFS, WAP, etc. In an example where HTTP is used, user system 112 might include an HTTP client commonly referred to as a “browser” for sending and receiving HTTP messages to and from an HTTP server at system 116. Such an HTTP server might be implemented as the sole network interface between system 116 and network 114, but other techniques might be used as well or instead. In some implementations, the interface between system 116 and network 114 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 116, shown in FIG. 1, implements a web-based customer relationship management (CRM) system. For example, in one embodiment, system 116 includes application servers configured to implement and execute CRM software applications as well as provide related data, code, forms, webpages and other information to and from user systems 112 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 116 implements applications other than, or in addition to, a CRM application. For example, system 16 may provide tenant access to multiple hosted (standard and custom) applications, including a CRM application. User (or third party developer) applications, which may or may not include CRM, may be supported by application platform 118, which manages creation, storage of the applications into one or more database objects and executing of the applications in a virtual machine in the process space of system 116.

One arrangement for elements of system 116 is shown in FIG. 1, including a network interface 120, application platform 118, tenant data storage 122 for tenant data 123, system data storage 124 for system data 125 accessible to system 116 and possibly multiple tenants, program code 126 for implementing various functions of system 116, and a process space 128 for executing MTS system processes and tenant-specific processes, such as running applications as part of an application hosting service. Additional processes that may execute on system 116 include database indexing processes.

Several elements in the system shown in FIG. 1 include conventional, well-known elements that are explained only briefly here. For example, each user system 112 could include a desktop personal computer, workstation, laptop, PDA, cell phone, or any wireless access protocol (WAP) enabled device or any other computing device capable of interfacing directly or indirectly to the Internet or other network connection. User system 112 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 112 to access, process and view information, pages and applications available to it from system 116 over network 114. Each user system 112 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 116 or other systems or servers. For example, the user interface device can be used to access data and applications hosted by system 116, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 112 and all of its components are operator configurable using applications, such as a browser, including computer code run using a central processing unit such as an Intel Pentium® processor or the like. Similarly, system 116 (and additional instances of an MTS, where more than one is present) and all of their components might be operator configurable using application(s) including computer code to run using a central processing unit such as processor system 117, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 116 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 116 is configured to provide webpages, forms, applications, data and media content to user (client) systems 112 to support the access by user systems 112 as tenants of system 116. As such, system 116 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 2 also illustrates environment 110. However, in FIG. 2 elements of system 116 and various interconnections in an embodiment are further illustrated. FIG. 2 shows that user system 112 may include processor system 112A, memory system 112B, input system 112C, and output system 112D. FIG. 2 shows network 114 and system 116. FIG. 2 also shows that system 116 may include tenant data storage 122, tenant data 123, system data storage 124, system data 125, User Interface (UI) 230, Application Program Interface (API) 232, PL/SOQL 234, save routines 236, application setup mechanism 238, applications servers 200₁-200_{N}, system process space 202, tenant process spaces 204, tenant management process space 210, tenant storage area 212, user storage 214, and application metadata 216. In other embodiments, environment 110 may not have the same elements as those listed above and/or may have other elements instead of, or in addition to, those listed above.

User system 112, network 114, system 116, tenant data storage 122, and system data storage 124 were discussed above in FIG. 1. Regarding user system 112, processor system 112A may be any combination of one or more processors. Memory system 112B may be any combination of one or more memory devices, short term, and/or long term memory. Input system 112C may be any combination of input devices, such as one or more keyboards, mice, trackballs, scanners, cameras, and/or interfaces to networks. Output system 112D may be any combination of output devices, such as one or more monitors, printers, and/or interfaces to networks. As shown by FIG. 2, system 116 may include a network interface 120 (of FIG. 1) implemented as a set of HTTP application servers 200, an application platform 118, tenant data storage 122, and system data storage 124. Also shown is system process space 202, including individual tenant process spaces 204 and a tenant management process space 210. Each application server 200 may be configured to tenant data storage 122 and the tenant data 123 therein, and system data storage 124 and the system data 125 therein to serve requests of user systems 112. The tenant data 123 might be divided into individual tenant storage areas 212, which can be either a physical arrangement and/or a logical arrangement of data. Within each tenant storage area 212, user storage 214 and application metadata 216 might be similarly allocated for each user. For example, a copy of a user's most recently used (MRU) items might be stored to user storage 214. Similarly, a copy of MRU items for an entire organization that is a tenant might be stored to tenant storage area 212. A UI 230 provides a user interface and an API 232 provides an application programmer interface to system 116 resident processes to users and/or developers at user systems 112. The tenant data and the system data may be stored in various databases, such as one or more Oracle™ databases.

Application platform 118 includes an application setup mechanism 238 that supports application developers' creation and management of applications, which may be saved as metadata into tenant data storage 122 by save routines 236 for execution by subscribers as one or more tenant process spaces 204 managed by tenant management process 210 for example. Invocations to such applications may be coded using PL/SOQL 234 that provides a programming language style interface extension to API 232. Invocations to applications may be detected by one or more system processes, which manage retrieving application metadata 216 for the subscriber making the invocation and executing the metadata as an application in a virtual machine.

Each application server 200 may be communicably coupled to database systems, e.g., having access to system data 125 and tenant data 123, via a different network connection. For example, one application server 200₁ might be coupled via the network 114 (e.g., the Internet), another application server 200_{N-1} might be coupled via a direct network link, and another application server 200_{N} might be coupled by yet a different network connection. Transfer Control Protocol and Internet Protocol (TCP/IP) are typical protocols for communicating between application servers 200 and the database system. However, it will be apparent to one skilled in the art that other transport protocols may be used to optimize the system depending on the network interconnect used.

In certain embodiments, each application server 200 is configured to handle requests for any user associated with any organization that is a tenant. Because it is desirable to be able to add and remove application servers from the server pool at any time for any reason, there is preferably no server affinity for a user and/or organization to a specific application server 200. In one embodiment, therefore, an interface system implementing a load balancing function (e.g., an F5 Big-IP load balancer) is communicably coupled between the application servers 200 and the user systems 112 to distribute requests to the application servers 200. In one embodiment, the load balancer uses a least connections algorithm to route user requests to the application servers 200. Other examples of load balancing algorithms, such as round robin and observed response time, also can be used. For example, in certain embodiments, three consecutive requests from the same user could hit three different application servers 200, and three requests from different users could hit the same application server 200. In this manner, system 116 is multi-tenant, wherein system 116 handles storage of, and access to, different objects, data and applications across disparate users and organizations.

As an example of storage, one tenant might be a company that employs a sales force where each salesperson uses system 116 to manage their sales process. Thus, a user might maintain contact data, leads data, customer follow-up data, performance data, goals and progress data, etc., all applicable to that user's personal sales process (e.g., in tenant data storage 122). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 116 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 116 might also maintain system level data usable by multiple tenants or other data. Such system level data might include industry reports, news, postings, and the like that are sharable among tenants.

In certain embodiments, user systems 112 (which may be client systems) communicate with application servers 200 to request and update system-level and tenant-level data from system 116 that may require sending one or more queries to tenant data storage 122 and/or system data storage 124. System 116 (e.g., an application server 200 in system 116) automatically generates one or more SQL statements (e.g., one or more SQL queries) that are designed to access the desired information. System data storage 124 may generate query plans to access the requested data from the database.

### Pre-Fetching Pages

In the following examples, one or more implementations are illustrated for pre-fetching data from a network host. Clearly, in alternate implementations, the illustrated processes and process steps may be combined into fewer steps, divided into more steps, and/or performed in a different sequence.

Particular embodiments include a method for pre-fetching data in an on-demand services environment. In one example, a user interface (UI) is provided for a user of the on-demand services environment. Log-in credentials for checking for the user can then be sent from a user system to a central server. A determination is then made as to whether the user should receive pre-fetched data that is stored on the server. If approved, the pre-fetched data is sent to the user in response to the determining and the checking of the log-in credentials. For example, the pre-fetched data can be data previously bookmarked by the user. As another example, the server can predict which data should be pre-fetched for that user based on historical usage patterns by the user.

For cases when a user wants to access a webpage, the user first may log on to a network system and attempts to go to the desired page. For example, user system 112 can log onto system 116 via network interface 120 in order to access the desired page. Instead of a server in system 116 constructing the requested page only after the request has been made by the user for sending that page to the user, the requested page can be “pre-fetched” and sent to user system 112 in advance of the user's request. Such an approach of particular embodiments reduces time otherwise consumed in the page accessing process, such as an authentication phase for the user, and then the request for the page.

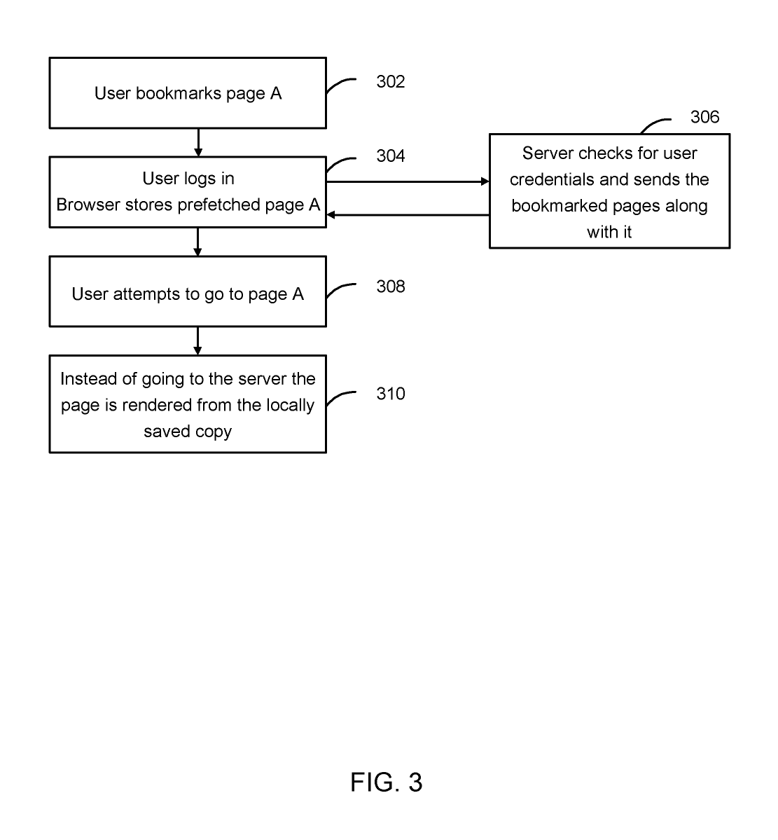

Referring now to FIG. 3, shown is an example block diagram illustrating pre-fetching webpages hosted on a network host in accordance with embodiments. Of course, as one skilled in the art will recognize, any piece of data that a user (e.g., a tenant in a multitenant system) wishes to access from a centralized server can be accommodated in particular embodiments. For example, any type of document, XML form, PDF file, database record, HTML file, interactive document data, audio and/or video media file, etc., can be pre-fetched as described herein. Thus, while a particular webpage pre-fetching example is described below, “pre-fetched data” can apply to any accessible form of data.

As shown in block 302, a user can bookmark a webpage that they regularly access. In one embodiment, the user does the bookmarking by clicking a control in a web browser, selecting a control on a webpage, or in any other suitable way. For example, a page or piece of data can be identified as “bookmarked” by the user indicating or tagging the accessed data as so bookmarked. A user can access a webpage and indicate via a menu selection on the web browser that the page is to be bookmarked. Such a user indication of bookmarking can inform the server that the page is bookmarked such that the server is able to store the bookmarked data (e.g., webpage information) with a tag or other indicator referencing that bookmarked data. In this fashion, the bookmarked data can be cashed on the server such that this data is “pre-fetched” or “pre-sent” by the server to the client/tenant at a user system.

Generally, the user should be logged into the network host in order to create and maintain a profile. The bookmarks may then be associated with the profile for storage by the network host or server. The server can store the bookmarked data in a suitable cache memory, such as any type of random access memory (RAM). Alternatively, the bookmark information may be stored in a cookie or some other user identifying way. In another example, bookmark information can be stored on a user system 112, and maybe automatically supplied upon login to the server (e.g., in system 116). The server may then use the bookmark information (e.g., an index, tag, indicator, etc.) in order to access corresponding bookmarked data. For example, the stored bookmark information can form a search key to be used by the server to directly access the bookmarked data, or to access a pointer to another storage for accessing the bookmarked data (e.g., via a content addressable memory (CAM), hash table, etc.). In any event, particular embodiments allow for the user to identify bookmarked data, and in response to that user logging in to the system, the user is automatically supplied the bookmarked data as pre-fetched data.

Once a webpage has been bookmarked, on subsequent visits to the webpage, as shown in block 304, user credentials are used by the network host to determine which if any webpages have been bookmarked. In one implementation, the user logs into the network system. The network host then checks for the user's login credentials and sends the bookmarked page/data along with the user login response, as shown in block 306. Alternatively, or in addition to the user bookmarking data, other information can also be used by the server to determine which data should be pre-fetched for that user. For example, the server may consider the user's activity history, including webpages previously visited by the user (e.g., via a user history, profile information, etc.), in order to predict the pages/data which would likely to be accessed by the user. Such predicted pages can then be pre-fetched and sent to the user, such as for local storage in the browser the user.

Thus, box 306 can include the server checking for user credentials, then checking for bookmarked pages. Alternatively, or in addition to the server checking for bookmarked pages, the server can also predict the pages likely to be visited by this user based on prior activities, or data likely to be accessed by this user. The predicted or bookmarked data/page (e.g., page A) can then be sent from the server to the user along with the appropriate authentication. In one implementation, the user's activity history is used by the network host to predict additional webpages the user is likely to visit by accessing a history file or profile information for the user. For example, the history file may be sent from the user to the network host or server upon login, or the file may be stored in the server. Such a history file can contain a list of recent webpages visited by the user.

The history file or profile information may also contain a list of all data accessed by the user from the server. The server can determine that data which was previously accessed by that user is likely to be accessed again by that user, even though the user has not necessarily indicated a bookmark for the page or placed any other identifier on the particular data. The server can also employ an algorithm designed to find webpages or other data closely related to this previously visited (e.g., per a history file, based on a user profile, etc.) information. Such an algorithm may operate like a search engine, and can employ a variety of other factors to predict such data for pre-fetching. For example, cross references to data accessed by other users who accessed the same page may be considered.

As another example, relatedness factors can be employed for each page in order to track similar pieces of data. Thus, a relatively high relatedness factor between two pages can indicate that each such page should be pre-fetched for the user. Any suitable approach for determining pages likely to be accessed by a user can be employed in particular embodiments. Based on such a determination, the network host can send such predicted pages to the user's computer to be stored as a local copy, as shown in block 304. When the user attempts to access the bookmarked page (block 308), in one embodiment, the page is rendered from the locally stored copy, as shown in block 310. Thus, there is no need to send another request from the user to the server in order to access the requested page. The requested page has been pre-fetched into local storage associated with the user for faster access by the user.

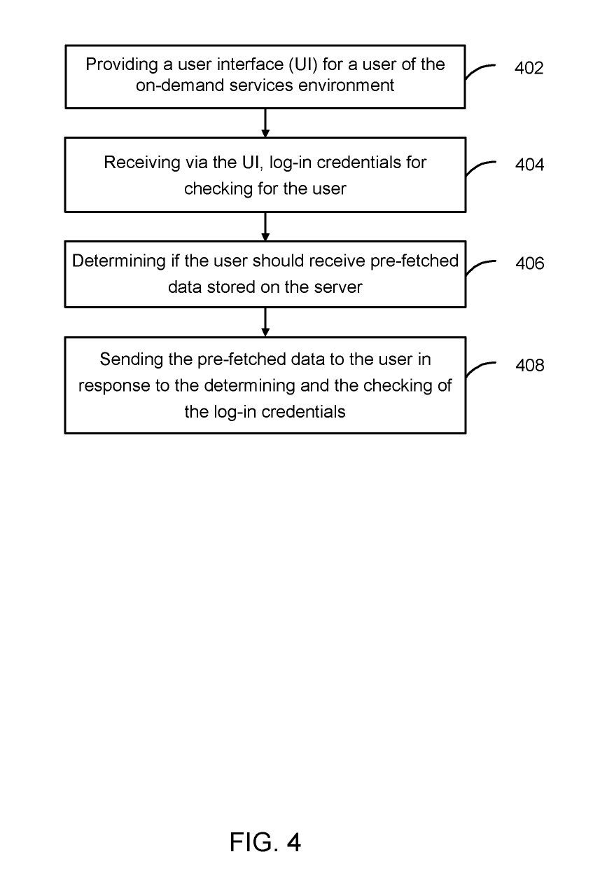

Referring now to FIG. 4, shown is an example flow diagram for server side pre-fetching. A user interface (UI) for a user of the on-demand services environment may be provided (e.g., from system 116 two user system 112), as shown in block 402. For example, such a UI can include controls for inputting and submitting a login name and password as part of the log-in credentials. The UI may also include any suitable input mechanism for the user to identify webpages or other data for bookmarking. For example, the UI may include a bookmark icon such that the user can click to add something to bookmark storage. In addition, the UI can include a screen for explicitly designating various pieces of data as bookmarked or otherwise suitable for pre-fetching. In one example, the user can access a screen and enter paths to files for bookmarking, such as by using file browser functionality. As another example, the UI can also include a box that can be checked for the user to enable or disable pre-fetching based on explicit bookmarks or on predictive approaches. Thus a user could tailor the pre-fetching functionality by indicating via the UI whether predictive approaches are to be employed at all for that user, which types of prediction can be employed (e.g., only that user's history, no use of relatedness factors, etc.), whether only explicit bookmarking is to be employed for that user, or any other suitable pre-fetching preference.

Once a user's login name and password have been submitted by the user to the network host or server, the network host can verify the user's log-in credentials, as shown in block 404. As part of this process, the server can load any associated bookmarks from the user, or otherwise access bookmark information (e.g., from storage on the server as referenced by an index or tag). In addition, and as discussed above, the server can predict pages or data which would likely to be visited or accessed by the user. Such predicted pages (e.g., via a user activity history, profile information, etc.) can be accessed and pre-sent in advance to the user, as shown in blocks 406 and 408. In some cases, a user employing explicit bookmarking can indicate that predicting pages is not to be employed. In other cases, such page and/or data prediction can be employed in addition to the use of explicit bookmarks. For example, profile information or other user settings can be employed such that the user can indicate whether access predictions are to be employed. Also, users may utilize the UI to adjust variables or parameters in order to improve the accuracy of the various page predictions, as discussed above.

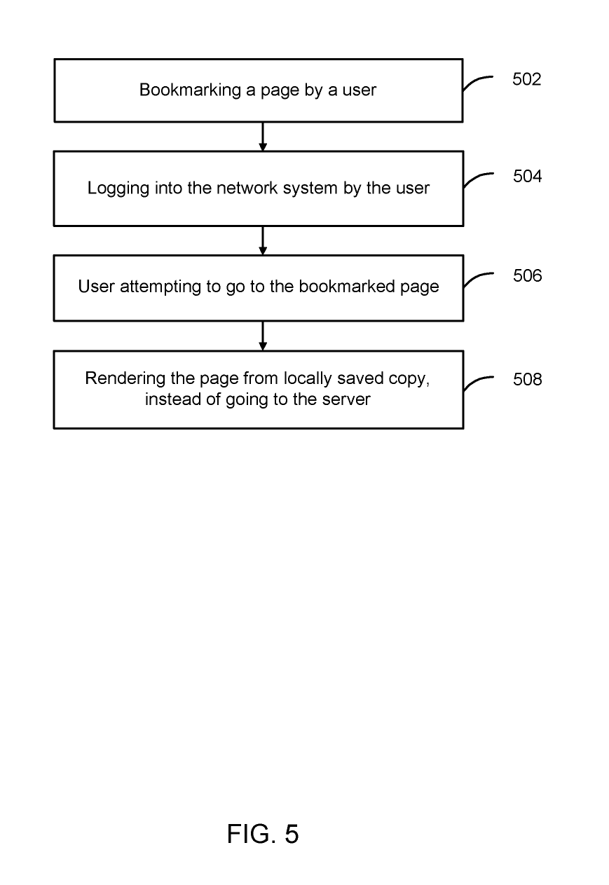

Referring now to FIG. 5, shown is a simplified flow diagram of pre-fetching on the client side. Initially, a user can bookmark a webpage for accessing that page regularly, as shown in block 502. As discussed above, any suitable indicator can be employed to save a bookmark for a particular page or piece of data. The user may log on to the network system when the user wants to access the bookmarked page, as shown in block 504. At the time of log in, the page is pre-fetched from the server, and stored locally at the user location. Depending upon the user's activity history, profile, and/or other factors discussed above, the server can also predict various pages which would likely be visited by the user, and provide those pages to the user for storage as a local copy. Next time the user logs in, when the user tries to attempt to access the bookmarked page or a predicted page, the page may be rendered from the locally saved copy, instead of directly from the server, as shown in blocks 506 and 508.

Particular examples of pre-fetching pages and records in an on-demand service environment have benefits of faster load times and better overall user experience. However, if a pre-fetched page gets updated from another session, such as another user's session for an interactive document, the pre-fetched page may become invalid or stale. This scenario can be handled by having a hash value associated with the pre-fetched page. When the user's browser requests access to a particular page that has been pre-fetched, the browser sends the hash value corresponding to the pre-fetched page. If the hash value remains the same, then the pre-fetched copy is determined to be still valid, and thus an updated copy of that page need not be sent from the server.

However, if the pre-fetched page is determined to be invalid via the hash value comparison, an updated page can be accessed from the server. In addition to hash values, time stamps can also be considered for determining if a pre-fetched page is valid. For example, each pre-fetched page can have a timestamp associated therewith for storage along with the user's local copy. For determining if this local copy is up-to-date, this associated timestamp can be sent from the user to the server or network host for comparison at the server against a corresponding timestamp for that pre-fetched page. In this way, a determination can be made as to whether the data previously provided from the server to the user is in fact invalid or stale. Thus, the server can automatically provide an updated copy of that pre-fetched data to the user.

As discussed above, server can also monitor a user's frequently visited set of pages, or other factors, and may predict the pages which are likely to be visited by the user. These predicted pages can also be pre-fetched or pre-sent to the client or user when the user logs in. This predicting may give a substantially the same benefit as if the user had bookmarked various predicted pages. In addition, any suitable predictive model can be used in particular embodiments, as discussed above. Users may also adjust variables or parameters in order to improve the accuracy of the page predictions. For example, a UI can be employed for such adjustments to the predictions, as discussed above.

Each database can generally be viewed as a collection of objects, such as a set of logical tables, containing data fitted into predefined categories. A “table” is one representation of a data object, and may be used herein to simplify the conceptual description of objects and custom objects according to the present invention. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for pre-fetching data in an on-demand services environment, the method comprising:
providing a user interface (UI) for a user of the on-demand services environment;
receiving via the UI, log-in credentials for checking for the user;
determining if the user should receive pre-fetched data stored on the server; and
sending the pre-fetched data to the user in response to the determining and the checking of the log-in credentials.

2. The method of claim 1, wherein determining comprises checking if the user has bookmarked a page.

3. The method of claim 1, wherein the pre-fetched data comprises the bookmarked page.

4. The method of claim 1, wherein the determining comprises predicting if the user would likely access a page, the predicted page being sent as the pre-fetched data.

5. The method of claim 1, further comprising:
receiving a request to access the pre-fetched data from the UI;
comparing a first time stamp associated with the pre-fetched data from the user against a second time stamp previously associated with the pre-fetched data by using a hash function; and
sending an updated version of the pre-fetched data to the user in response to the first and second time stamps not matching.

6. A computer-readable storage medium having one or more instructions thereon for pre-fetching pages and records in an on-demand services environment, the instructions when executed by one or more processors causing the one or more processors to carry out:
providing a user interface (UI) for a user of the on-demand services environment;
receiving via the UI, log-in credentials for checking for the user;
determining if the user should receive pre-fetched data stored on the server; and
sending the pre-fetched data to the user in response to the determining and the checking of the log-in credentials.

7. The computer-readable storage medium of claim 6, wherein the determining comprises checking if the user has bookmarked a page.

8. The computer-readable storage medium of claim 6, wherein the pre-fetched data comprises the bookmarked page.

9. The computer-readable storage medium of claim 6, wherein the determining comprises predicting if the user would likely access a page, the predicted page being sent as the pre-fetched data.

10. The computer-readable storage medium of claim 6, wherein the instructions when executed further cause the one or more processors to carry out:
receiving a request to access the pre-fetched data from the UI;
comparing a first time stamp associated with the pre-fetched data from the user against a second time stamp previously associated with the pre-fetched data by using a hash function; and
sending an updated version of the pre-fetched data to the user in response to the first and second time stamps not matching.

11. An apparatus for pre-fetching pages and records in an on-demand services environment, the apparatus comprising:
a processor; and
one or more stored sequences of instructions which, when executed by the processor, cause the processor to carry out:
providing a user interface (UI) for a user of the on-demand services environment;
receiving via the UI, log-in credentials for checking for the user;
determining if the user should receive the pre-fetched data stored on the server; and
sending the pre-fetched data to the user in response to the determining and the checking of the log-in credentials.

12. The apparatus of claim 11, wherein the determining comprises checking if the user has bookmarked a page.

13. The apparatus of claim 11, wherein the pre-fetched data comprises the bookmarked page.

14. The apparatus of claim 11, wherein the determining comprises predicting if the user would likely access a page, the predicted page being sent as the pre-fetched data.

15. The apparatus of claim 11, wherein the instructions when executed further cause the processor to carry out:
receiving a request to access the pre-fetched data from the UI;
comparing a first time stamp associated with the pre-fetched data from the user against a second time stamp previously associated with the pre-fetched data by using a hash function; and
sending an updated version of the pre-fetched data to the user in response to the first and second time stamps not matching.
